(19) United States
(12) Patent Application Publication
(10) Pub. No.: US 2006/0151245 A1
(43) Pub. Date: Jul. 13, 2006

(54) Four-point stepladder bracing system, brace and method

(75) Inventor: Russell Scott Patton, Jamestown, PA (US)

Correspondence Address: Ansel M. Schwartz, Suite 304, 201 N. Craig Street, Pittsburgh, PA, 15213, US

(73) Assignee: Werner Co.

(21) Appl. No.: 11/031,215

(22) Filed: Jan. 7, 2005

(51) Int. Cl. E06C 7/10

(52) U.S. Cl. 182/217

(57) ABSTRACT

A ladder includes a first rail. The ladder includes a second rail. The ladder includes a step attached to the first rail and the second rail. The ladder includes a first brace attached to the first rail. The ladder includes a second brace attached to the second rail. Each brace is attached at least at two distinct points to the step and at least at two distinct points to a respective rail. A brace for supporting a step to first and second rails of a ladder includes a central portion. The brace includes a rail portion extending from the central portion which attaches to a respective rail. The brace includes a step portion extending from the central portion which attaches to the step. A method for using a ladder. The method includes the steps of placing a load on a step. There is the step of distributing the load to the rails from the step through a first and second brace attached to the first and second rails, respectively. Each brace is attached at least at two distinct points to the step and at least at two distinct points to a respective rail.

### FIELD OF THE INVENTION

The present invention is related to reinforcing the step to rail connection in a stepladder. More specifically, the present invention is related to reinforcing the step to rail connection in a stepladder with a 4-point bracing system.

### BACKGROUND OF THE INVENTION

Current stepladder designs have 2 different types of bracing. There are braces at the bottom of the ladder that double as feet and sometimes are coupled with rail shields. The second type of bracing is used throughout the upper portion of the ladder. It is a 2-point system that has one fastener attaching the brace to the step, and one fastener attaching the brace to the rail. The present invention is designed to be an improvement to the latter type of bracing system.

### SUMMARY OF THE INVENTION

The present invention pertains to a ladder. The ladder comprises a first rail. The ladder comprises a second rail. The ladder comprises a step attached to the first rail and the second rail. The ladder comprises a first brace attached to the first rail. The ladder comprises a second brace attached to the second rail. Each brace is attached at least at two distinct points to the step and at least at two distinct points to a respective rail.

The present invention pertains to a method for using a ladder. The method comprises the steps of placing a load on a step. There is the step of distributing the load to the rails from the step through a first and second brace attached to the first and second rails, respectively. Each brace is attached at least at two distinct points to the step and at least at two distinct points to a respective rail.

The present invention pertains to a brace for supporting a step to first and second rails of a ladder. The brace comprises a central portion. The brace comprises a rail portion extending from the central portion which attaches to a respective rail. The brace comprises a step portion extending from the central portion which attaches to the step.

### BRIEF DESCRIPTION OF THE DRAWINGS

In the accompanying drawings, the preferred embodiment of the invention and preferred methods of practicing the invention are illustrated in which:

FIG. 1 shows a ladder having a first embodiment of a brace of the present invention.

FIG. 2 shows a ladder having a second embodiment of a brace of the present invention.

FIG. 3 shows the first embodiment of the brace.

FIG. 4 shows the second embodiment of the brace.

FIG. 5 shows pressure applied to the Center of the Step.

FIG. 6 shows pressure applied to a 3.75″ width near −X Rail.

FIG. 7 shows loads applied to Line on Step (FX=−10 and FY=−40).

### DETAILED DESCRIPTION

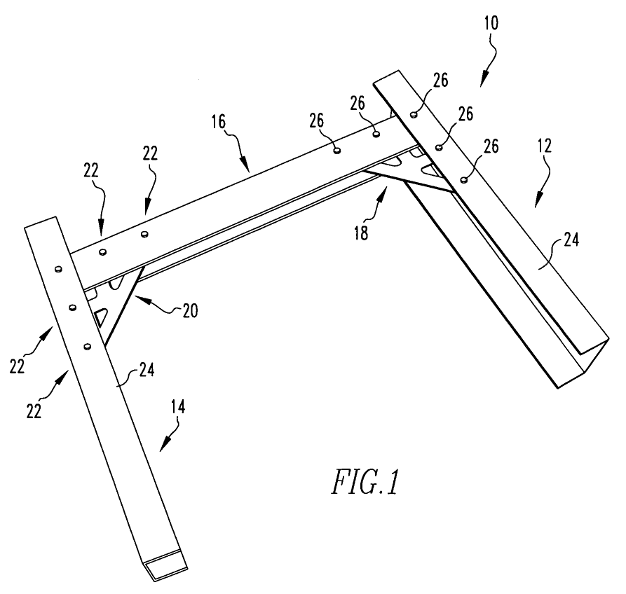

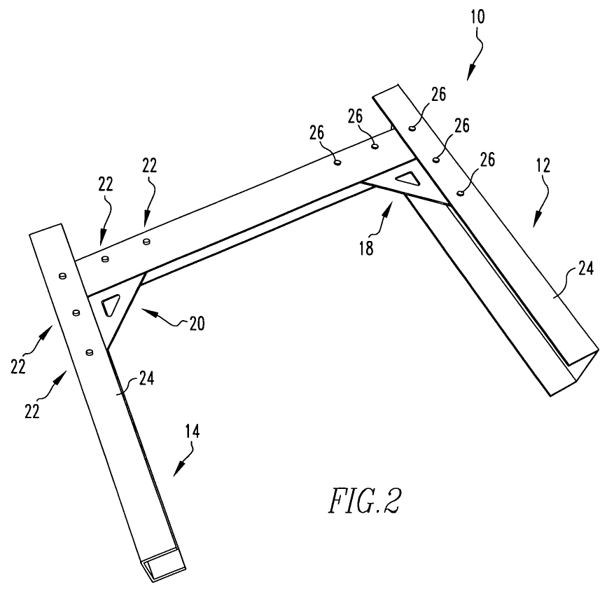

Referring now to the drawings wherein like reference numerals refer to similar or identical parts throughout the several views, and more specifically to FIGS. 1 and 2 thereof, there is shown a ladder 10. The ladder 10 comprises a first rail 12. The ladder 10 comprises a second rail 14. The ladder 10 comprises a step 16 attached to the first rail 12 and the second rail 14. The ladder 10 comprises a first brace 18 attached to the first rail 12. The ladder 10 comprises a second brace 20 attached to the second rail 14. Each brace is attached at least at two distinct points to the step 16 and at least at two distinct points to a respective rail.

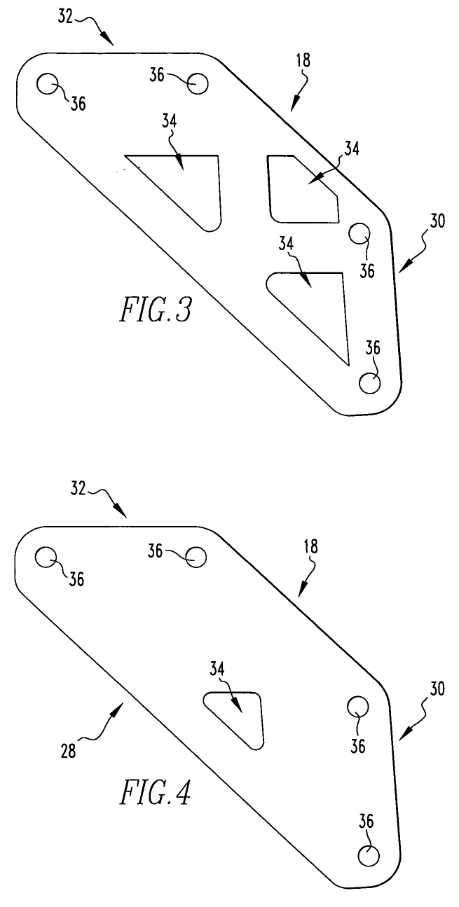

Preferably, each rail has a front flange 24 and each brace is attached to the front flange 24 of the respective rail. Each brace is preferably attached to the step 16 and the respective rail with fasteners 26. Preferably, each brace has a central portion 28, a rail portion 30 extending from the central portion 28 which attaches to a respective rail, and a step 16 portion extending from the central portion 28 which attaches to the step 16, as shown in FIGS. 3 and 4. The central portion 28 preferably has at least one gap 34, and the rail portion 30 and the step 16 portion each have at least two holes 36 through which the fasteners 26 extend to attach the brace to the respective rail and step 16.

The present invention pertains to a brace for supporting a step 16 to first and second rails 12, 14 of a ladder 10. The brace comprises a central portion 28, as shown in FIGS. 3 and 4. The brace comprises a rail portion 30 extending from the central portion 28 which attaches to a respective rail. The brace comprises a step 16 portion extending from the central portion 28 which attaches to the step 16.

Preferably, the central portion 28 has at least one gap 34, and the rail portion 30 and the step 16 portion each have at least two holes 36 through which the fasteners 26 extend to attach the brace to the respective rail and step 16.

The present invention pertains to a method for using a ladder 10. The method comprises the steps of placing a load on a step 16. There is the step of distributing the load to the rails from the step 16 through a first and second brace 18, 20 attached to the first and second rails 12, 14, respectively. Each brace is attached at least at two distinct points to the step 16 and at least at two distinct points to a respective rail.

In the operation of the invention, the 4-point bracing system has what amounts to 5 separate connections for the step 16 to the side rail front flange 24 in a step ladder. The step 16 is directly attached to the front flange 24 of the side rail with one or two fasteners 26. Then a 4-point brace is added by using 2 additional fasteners 26 to attach the brace to the step 16 flange, and 2 more fasteners 26 to attach the brace to the side rail front flange 24. See FIGS. 1-4.

The improvement gained with this type of bracing is to distribute the stresses in the step 16 and rail interface under different types of loading conditions. Modeling was done to simulate combination vertical and horizontal load conditions being applied to the top step 16 and to the middle step 16 of stepladders. It was found that there was an approximate 30% reduction in peak stresses at the top step 16 area, and a reduction of approximately 36% at the area around the middle step 16.

Table 1 shows the stress analysis done and the results indicating the reduction in peak stress on the front flange 24 of the rail.

TABLE 1
Bending Stress in Rail

| | | | | Region SX Stress Using | | |
|---|---|---|---|---|---|---|
| | Max SX Stress in Rail | | | Rsys 21 for +Z Rail | | |
| | Set 1 | Set 2 | Set 3 | Set 1 | Set 2 | Set 3 |
| Ladder Loaded on Top Step | | | | | | |
| No Bracing | 33,040 | 24,416 | 100,000 | 4,500 | 6,000 | 18,000 |
| Standard Brace | 29,490 | 23,610 | 105,960 | 4,000 | 5,500 | 11,000 |
| K-Brace | 30,100 | 17,900 | 70,300 | 3,000 | 4,000 | 12,100 |
| Ladder Loaded on Middle Step | | | | | | |
| No Bracing | 36,840 | 25,100 | 78,200 | 4,000 | 2,000 | 11,000 |
| Standard Brace | 38,900 | 22,310 | 61,200 | 4,500 | 5,000 | 6,500 |
| K-Brace | 41,170 | 24,300 | 49,380 | 3,400 | 5,000 | 6,300 |
| Integrated K-Brace | 38,460 | 21,970 | 51,580 | 4,500 | 6,000 | 7,500 |
| Integrated K-Brace— | 39,170 | 20,700 | 49,420 | 4,500 | 5,100 | 7,500 |
| Version 2 | | | | | | |

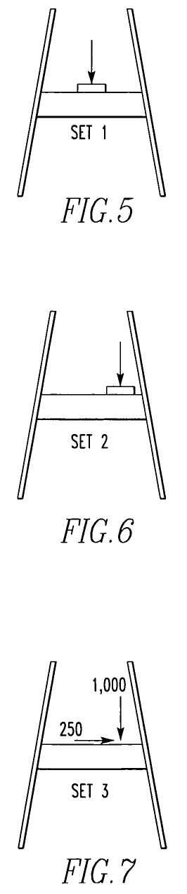

Set 1 −> Pressure Applied to the Center of the Step. See FIG. 5.
Set 2 −> Pressure Applied to a 3.75″ width near −X Rail. See FIG. 6.
Set 3 −> Loads Applied to Line on Step (FX = −10 and FY = −40). See FIG. 7.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A ladder comprising:
a first rail;
a second rail;
a step attached to the first rail and the second rail;
a first brace attached to the first rail; and
a second brace attached to the second rail, each brace attached at least at two distinct points to the step and at least at two distinct points to a respective rail.

2. A ladder as described in claim 1 wherein each rail has a front flange and each brace is attached to the front flange of the respective rail.

3. A ladder as described in claim 2 wherein each brace is attached to the step and the respective rail with fasteners.

4. A ladder as described in claim 3 wherein each brace has a central portion, a rail portion extending from the central portion which attaches to a respective rail, and a step portion extending from the central portion which attaches to the step.

5. A ladder as described in claim 4 wherein the central portion has at least one gap, and the rail portion and the step portion each have at least two holes through which the fasteners extend to attach the brace to the respective rail and step.

6. A brace for supporting a step to first and second rails of a ladder comprising:
a central portion;
a rail portion extending from the central portion which attaches to a respective rail; and
a step portion extending from the central portion which attaches to the step.

7. A brace as described in claim 6 wherein the central portion has at least one gap, and the rail portion and the step portion each have at least two holes through which the fasteners extend to attach the brace to the respective rail and step.

8. A method for using a ladder comprising the steps of:
placing a load on a step; and
distributing the load to the rails from the step through a first and second brace attached to the first and second rails, respectively, each brace attached at least at two distinct points to the step and at least at two distinct points to a respective rail.
